(19) United States
(12) Patent Application Publication
(10) Pub. No.: US 2014/0037207 A1
(43) Pub. Date: Feb. 6, 2014

(54) SYSTEM AND A METHOD OF ADAPTIVELY SUPPRESSING FALSE-COLOR ARTIFACTS

(71) Applicant: MEI-JU CHEN, Tainan City (TW)

(72) Inventor: MEI-JU CHEN, Tainan City (TW)

(73) Assignee: HIMAX IMAGING LIMITED, Tainan City (TW)

(21) Appl. No.: 13/564,644

(22) Filed: Aug. 1, 2012

(51) Int. Cl. G06K 9/40

(52) U.S. Cl. 382/167

(57) ABSTRACT

A system and a method of adaptively suppressing false-color artifacts are disclosed. A luma spatial frequency unit detects edges or an area with a substantially high luma spatial frequency within an active window, and a chroma spatial frequency unit detects substantial fluctuations in colors within the active window. A false-color detector determines occurrence of false-color artifacts according to results of the luma spatial frequency unit and the chroma spatial frequency unit. A compensator performs compensation on chroma components if the false-color detector decides that the false-color artifacts occur.

### BACKGROUND OF THE INVENTION

1. Field of the Invention

The present invention generally relates to an image sensor, and more particularly to a system and a method of adaptively suppressing false-color artifacts due to interpolation.

2. Description of Related Art

A Bayer color filter array (CFA), named after its inventor Dr. Bryce E. Bayer from Eastman Kodak, is widely used in digital image capture devices (such as digital still cameras), and is commonly placed over pixel sensors of a (black-and-white) image sensor to capture color image data. The Bayer CFA has a filter pattern typically made up of 50% green (G), 25% red (R) and 25% blue (B). FIG. 1A shows the filter pattern of a typical Bayer CFA. FIG. 1B shows decomposition of the Bayer CFA of FIG. 1A into three under-sampling image planes.

Although the Bayer CFA is capable of capturing color image data with low image capture cost, the Bayer CFA, however, imposes the need for interpolation of missing color data (i.e., the voids shown in FIG. 1B) to create three complete color image planes. Reduction in sharpness of the luminance and chrominance inevitably incurs during the interpolation, therefore reducing image quality. For the worse, false-color artifacts (or color aliasing artifacts) further result from incomplete sampling in the image planes and spatial phase differences among the color channels of the Bayer CFA. The false-color artifacts disturb viewers more severely than the reduced sharpness.

In order to suppress the false-color artifacts, an optical blur filter (or an anti-aliasing filter or an optical low-pass filter) is usually employed, as discussed in “Investigation of Color Aliasing of High Spatial Frequencies and Edges for Bayer-Pattern Sensors and Foveon X3® Direct Image Sensors” by Rudolph J. Guttosch, the disclosure of which is incorporated herein by reference.

Nevertheless, the blur filter reduces false-color artifacts at the expense of image sharpness. Further, use of the blur filter raises manufacturing cost. Moreover, inclusion of the blur filter in digital image capture devices increases device size and weight, making minimization in portable digital image capture devices, such as cell phones, less viable.

Accordingly, a need has thus arisen to propose a novel scheme of suppressing false-color artifacts in a more effective and economic manner.

### SUMMARY OF THE INVENTION

In view of the foregoing, the embodiment of the present invention provides a system and a method of adaptively suppressing false-color artifacts due to interpolation on image data of an image sensor with a color filter array.

According to one embodiment, a system of adaptively suppressing false-color artifacts includes an interpolator, a converter, a luma spatial frequency unit, a chroma spatial frequency unit, a false-color detector and a compensator. The interpolator performs interpolation on raw image data outputted from an image sensor to obtain color interpolated data. The converter converts the interpolated data into a color space to result in converted data, each of which is represented by a luma component and at least one chroma component in the converted color space. The luma spatial frequency unit detects edges or an area with a substantially high luma spatial frequency within an active window, and the chroma spatial frequency unit detects substantial fluctuations in colors within the active window. The false-color detector determines occurrence of false-color artifacts according to results of the luma spatial frequency unit and the chroma spatial frequency unit. The compensator performs compensation on the chroma components if the false-color detector decides that the false-color artifacts occur, thereby resulting in compensated chroma components.

### BRIEF DESCRIPTION OF THE DRAWINGS

FIG. 1A shows a filter pattern of a typical Bayer color filter array (CFA);

FIG. 1B shows decomposition of the Bayer CFA of FIG. 1A into three under-sampling image planes;

FIG. 2 shows a block diagram. illustrating a system of adaptively suppressing false-color artifacts according to one embodiment of the present invention;

FIG. 3 shows a flow diagram of a method associated with the illustrated system of FIG. 2;

FIG. 4 shows exemplary interpolation algorithms performed on R, G and B image data outputted from a Bayer image sensor; and

FIG. 5 shows an active (3×3) window covering data d0-d8 and an exemplary associated HPF algorithm.

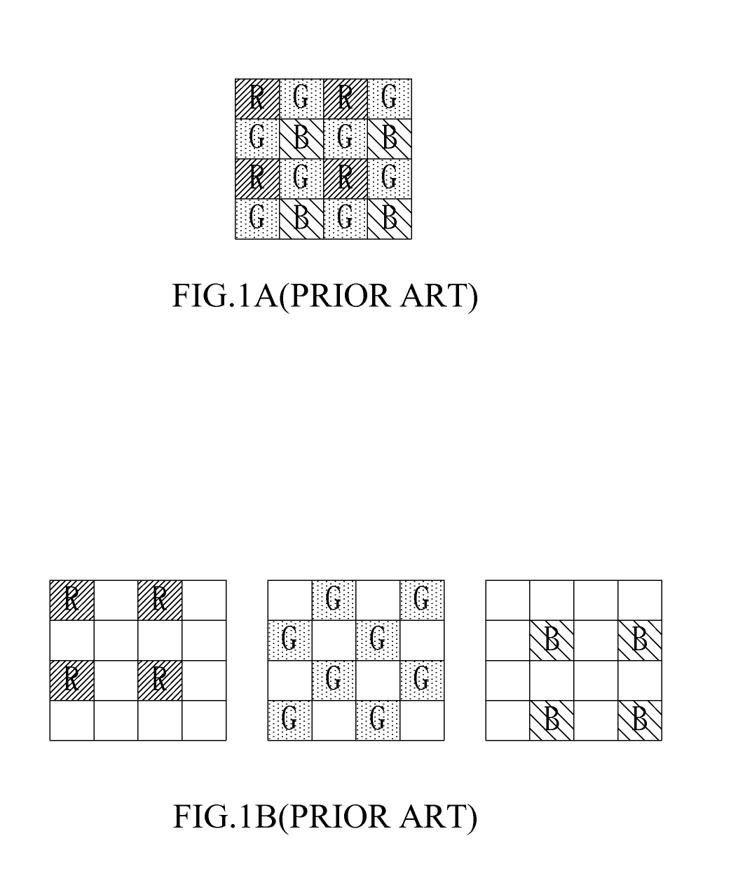

### DETAILED DESCRIPTION OF THE INVENTION

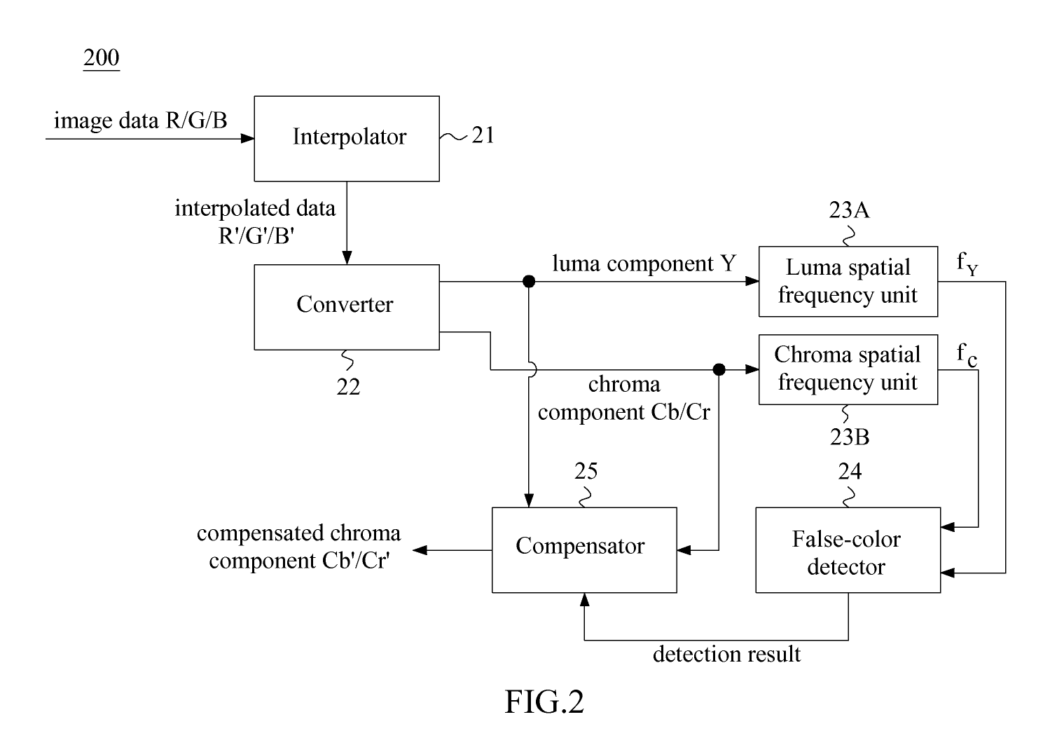

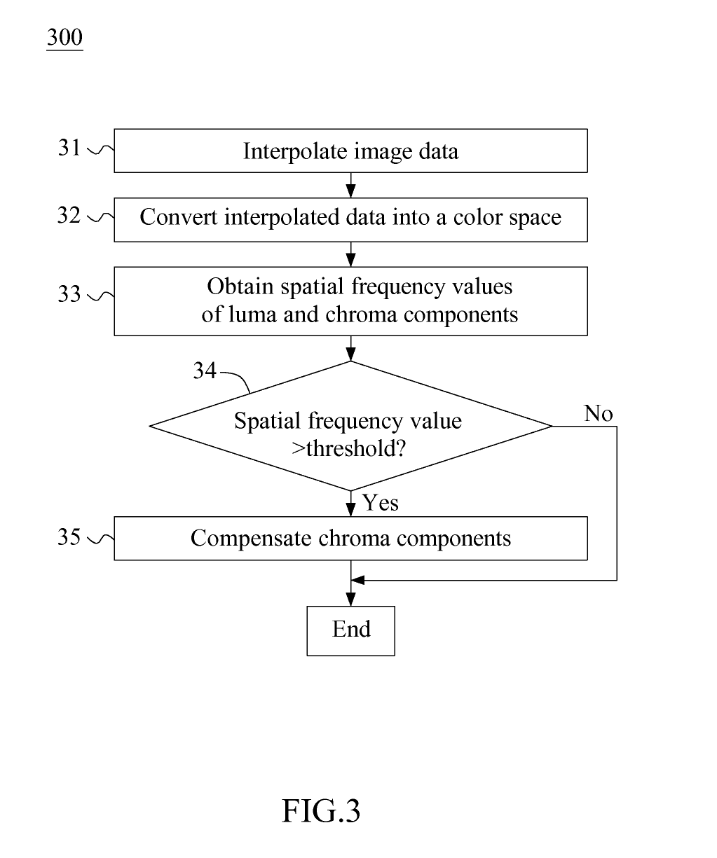

FIG. 2 shows a block diagram illustrating a system 200 of adaptively suppressing false-color artifacts according to one embodiment of the present invention, and FIG. 3 shows a flow diagram of a method 300 associated with the illustrated system 200 of FIG. 2. The illustrated system 200 and method 300 may be adapted to an image sensor with a color filter array (CFA), such as a Bayer CFA, placed over pixel sensors of the image sensor. Although the Bayer CFA is demonstrated in the embodiment, it is appreciated that the embodiment of the present invention may, in general, be adapted to an image sensor with a CFA other than the Bayer CFA. The blocks of the illustrated system 200 and the steps of the illustrated method 300 may, but not necessarily, be implemented by appropriate circuits or a processor (such as a digital signal processor).

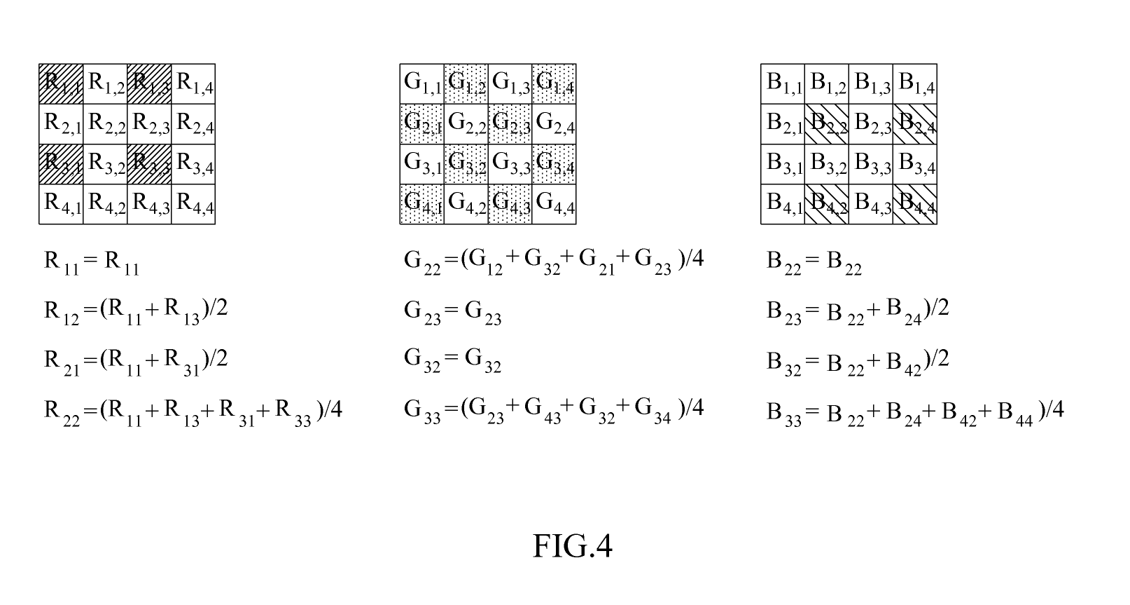

In the embodiment, in step 31, raw image data (e.g., red (R) data, green (G) data and blue (B) data) outputted from an image sensor (e.g., a Bayer image sensor) are interpolated by an interpolator 21, in order to obtain a set of complete red, green, and blue interpolated data R′/G′/B′ for each pixel. FIG. 4 shows exemplary interpolation algorithms performed on R, G and B image data outputted from a Bayer image sensor.

Subsequently, in step 32, the interpolated data (e.g., R′/G′/B′) are then converted by a converter 22 into another color space, in which the converted data may be represented by a luma component and at least one chroma component. For example, in the embodiment, the interpolated data may be converted into YCbCr, in which Y represents a luma component, Cb represents a hue-difference chroma component, and Cr represents a red-difference chroma component. Although YCbCr is exemplified in the embodiment, it is appreciated that other color spaces, such as YUV, may be used instead. In YUV, Y represents a luma component, and UV represent two chroma components.

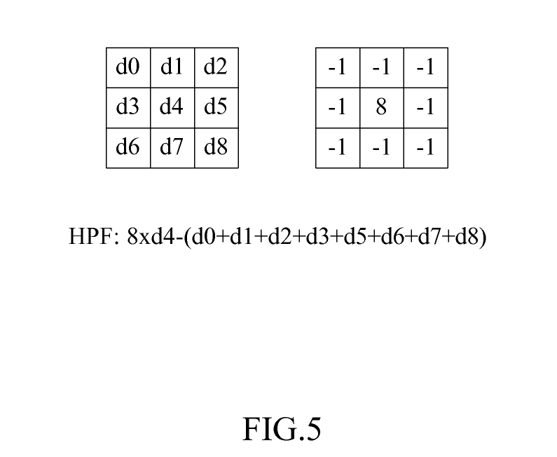

In step 33, the luma components (e.g., Y) and the chroma components (e.g., Cb and/or Cr) covered by an active window (or moving window) are fed to a luma spatial frequency unit 23A and a chroma spatial frequency unit 93B, respectively, for correspondingly obtaining a luma spatial frequency value (e.g., f_{Y}) of the luma components and at least one chroma spatial frequency value (e.g., f_{Cb} and/or f_{Cr}) of the chroma components. To be more specific, the luma spatial frequency unit 23A is utilized to determine a luma spatial frequency value f_{Y} of the luma components of the converted data covered, by an active window, for example, by a high pass filter (HPF), and the chroma spatial frequency unit 23B is utilized, to determine at least one chroma spatial frequency value f_{C} of the chroma components of the converted data covered by the active window. FIG. 5 shows an active (3×3) window covering data d0-d8 and an exemplary associated HPF algorithm. It is noted that the algorithm used in the luma spatial frequency unit 23A need not be the same as the algorithm used in the chroma spatial frequency unit 23B.

In step 34, the luma/chroma spatial frequency values (f_{Y}, f_{C}) of the luma components and the chroma. components are then fed to a false-color detector 24 for determining occurrence (or presence) of false-color artifacts. In the embodiment, if (1) the luma spatial. frequency value f_{Y} of the luma components Y (within an active window) is greater than a predetermined luma threshold, indicating that a substantially high luma frequency is present, and (2) at least one chroma spatial frequency value f_{C} of the chroma components of Cb and/or Cr (within the active window) is greater than a predetermined chroma threshold, indicating that a substantially high chroma frequency is present, the false-color detector 24 accordingly decides that false-color artifacts may occur. The rationale for using the false-color detector 24 to determine the occurrence of the false-color artifacts, in the embodiment, is based on the facts that the false-color artifacts normally occur in edges or high-spatial-frequency area (i.e., an area with a substantially high luma spatial frequency) and the false-color artifacts possess great fluctuations in colors (i.e., have a substantially high chroma spatial frequency).

If the false-color detector 24 decides that the false-color artifacts occur, the chroma components (Cb and/or Cr) are then subjected to compensation (step 35) by a compensator 25 in order to suppress false-color effect due to the interpolation, thereby resulting in compensated chroma components Cb′/Cr′. As a result, the fluctuations in colors due to the false-color artifacts may be substantially and effectively suppressed. On the other hand, if the false-color detector 24 decides that the false-color artifacts do not occur, the chroma components (Cb and Cr) are then passed without compensation. In other words, whether the chroma components (Cb and/or Cr) are subjected to compensation (step 35) by the compensator 25 is based on (or controlled by) a detection result of the false-color detector 24.

In one embodiment, the compensator 25 performs compensation in an amount (or an extent) in accordance with the luma spatial frequency value f_{Y} of the luma components. In another embodiment, the compensator 25 performs compensation in an amount in accordance with both (1) the luma spatial frequency value f_{Y} of the luma components Y and (2) at least one chroma spatial frequency value f_{C} of the chroma components Cb and/or Cr.

Although specific embodiments have been illustrated and described, it will be appreciated by those skilled in the art that various modifications may be made without departing from the scope of the present invention, which is intended to be limited solely by the appended claims.

1. A system of adaptively suppressing false-color artifacts, comprising:
an interpolator configured to perform interpolation on raw image data outputted from an image sensor to obtain color interpolated data;
a converter configured to convert the interpolated data into a color space to result in converted data, each of which is represented by a luma component and at least one chroma component in the converted color space;
a luma spatial frequency unit configured to detect edges or an area with a luma spatial frequency being higher than a predetermined value within an active window;
a chroma spatial frequency unit configured to detect substantial fluctuations in colors within the active window;
a false-color detector configured to determine occurrence of false-color artifacts according to results of the luma spatial frequency unit and the chroma spatial frequency unit; and
a compensator configured to perform compensation on the chroma components if the false-color detector decides that the false-color artifacts occur, thereby resulting in compensated chroma components.

2. The system of claim 1, wherein the luma spatial frequency unit obtains a luma spatial frequency value of the luma components covered by the active window, and the chroma spatial frequency unit obtains at least one chroma spatial frequency value of the chroma components covered by the active window.

3. The system of claim 2, wherein the luma spatial frequency unit or the chroma spatial frequency unit comprises a high pass filter.

4. The system of claim 2, wherein the false-color detector decides that the false-color artifacts occur when the luma spatial frequency value is greater than a predetermined luma threshold, and the at least one chroma spatial frequency value is greater than a predetermined chroma threshold.

5. The system of claim 2, wherein the compensator performs compensation in an amount in accordance with the luma spatial frequency value.

6. The system of claim 2, wherein the compensator performs compensation in an amount in accordance with both the luma spatial frequency value and the at least one chroma spatial frequency value.

7. The system of claim 1, wherein the image sensor is a Bayer image sensor.

8. The system of claim 1, wherein the interpolated data are converted from RGB into YCbCr.

9. A method of adaptively suppressing false-color artifacts, comprising:
interpolating raw image data outputted from an image sensor to obtain color interpolated data;
converting the interpolated data into a color space to result in converted data, each of which is represented by a luma component and at least one chroma component in the converted color space;
performing a luma spatial frequency detection step to detect edges or an area with a luma spatial frequency being higher than a predetermined value within an active window;
performing a chroma spatial frequency detection step to detect substantial fluctuations in colors within the active window;
determining occurrence of false-color artifacts according to results of the luma spatial frequency detection step and the chroma spatial frequency detection step; and
compensating the chroma components if the false-color artifacts occur, thereby resulting in compensated chroma components.

10. The method of claim 9, wherein a luma spatial frequency value of the luma components covered by the active window is obtained in the luma spatial frequency detection step, and at least one chroma spatial frequency value of the chroma components covered by the active window is obtained in the chroma spatial frequency detection step.

11. The method of claim 10, wherein the luma spatial frequency detection step or the chroma spatial frequency detection step comprises high pass filtering.

12. The method of claim 10, wherein the false-color artifacts occur when the luma spatial frequency value is greater than a predetermined luma threshold, and the at least one chroma spatial frequency value is greater than a predetermined chroma threshold.

13. The method of claim 10, wherein the compensation is performed in an amount in accordance with the luma spatial frequency value.

14. The method of claim 10, wherein the compensation is performed in an amount in accordance with both the luma spatial frequency value and the at least one chroma spatial frequency value.

15. The method of claim 9, wherein the image sensor is a Bayer image sensor.

16. The method of claim 9, wherein the interpolated data are converted from RGB into YCbCr.
